(19) United States
(12) Patent Application Publication
(10) Pub. No.: US 2005/0126840 A1
(43) Pub. Date: Jun. 16, 2005

(54) Bicycle with a slant backrest frame

(75) Inventor: Sonny Lin, Changhua City (TW)

Correspondence Address: TROXELL LAW OFFICE PLLC, 5205 LEESBURG PIKE, SUITE 1404, FALLS CHURCH, VA, 22041, US

(73) Assignee: NAVAJO INDUSTRIAL CO., LTD.

(21) Appl. No.: 10/731,471

(22) Filed: Dec. 10, 2003

(51) Int. Cl. B62K 11/00

(52) U.S. Cl. 180/205

(57) ABSTRACT

A bicycle with a slant backrest frame includes a bicycle embodiment, and a power unit wherein the bicycle embodiment is equipped with a saddle having a slant backrest, and a rectangular central tube disposed under the saddle thereof in communication with a lower tube to which a switch device is fixedly attached at a preset position. The power unit made up of a rear loading bracket and a storage battery is adapted to the central tube with the rear loading bracket securely fixed to a slant flat opening of the central tube and the storage battery retained at a receiving cavity of the central tube therein. In practical use, the bicycle embodiment can be either pedaled by feet or electrically moved via the power unit conductively linked to the switch device thereof. Besides, first/second electrical wires of the switch device and first/second conducting wires of the storage battery thereof are concealed at the central and the lower tubes therein for protection thereof as well as the overall beauty of the bicycle embodiment thereof. Moreover, via the separate design of the power unit and the bicycle embodiment thereof, the storage battery can be individually withdrawn from the receiving cavity thereof for recharging, enable a rider to make use of the bicycle embodiment without waiting for the completion of the charging operation thereof.

### BACKGROUND OF THE INVENTION

The present invention is related to a bicycle with a slant backrest frame, including a bicycle embodiment, and a power unit wherein the bicycle embodiment is equipped with a saddle having a slant backrest, and a central tube disposed under the saddle thereof in communication with a lower tube to which a switch device is fixedly attached at a preset position. The power unit made up of a rear loading bracket and a storage battery is joined to the central tube with the rear loading bracket securely fixed to a slant flat opening of the central tube and the storage battery adapted at a receiving cavity therein; whereby, the bicycle embodiment can be either pedaled by feet or electrically moved via the power unit conductively linked to the switch device thereof. Besides, first/second electrical and conducting wires of the switch device and the storage battery thereof respectively are concealed at the central and the lower tubes therein for protection thereof as well as the overall beauty of the bicycle embodiment. Moreover, the storage battery can be easily withdrawn from the receiving cavity thereof for recharging, enable a rider to make use of the bicycle embodiment without waiting for the completion of the charging operation thereof.

A conventional bicycle with a slant backrest frame can only be moved by pedaling with both feet without any electrically powered mechanism adapted thereto. Due to the design of pedaling, a rider can't sit back comfortably on the saddle with the back leaned properly against the backrest of the bicycle, greatly reducing the function of the backrest thereof.

### SUMMARY OF THE PRESENT INVENTION

It is, therefore, the primary purpose of the present invention to provide a bicycle with a slant backrest frame, including a bicycle embodiment and a power unit wherein, via the power unit conductively linked to a switch device, the bicycle embodiment can be either pedaled by both feet or electrically powered via the power unit so that a rider can freely choose to turn on the power unit via the switch device and sit back comfortably on a saddle of the bicycle embodiment with the back leaned properly against a slant backrest of the saddle thereof, facilitating the use of the slant backrest thereof.

It is, therefore, the second purpose of the present invention to provide a bicycle with a slant backrest frame wherein the power unit is made up of a rear loading bracket and a storage battery, and the bicycle embodiment is equipped with a central tube having a receiving cavity disposed at the inner side thereof in communication with a lower tube; whereby, first/second electrical wires of the switch device and first/second conducting wires of the storage battery thereof are concealed at the central and lower tubes therein for the purpose of protection thereof as well as achieving the overall beauty of the bicycle embodiment thereof.

It is, therefore, the third purpose of the present invention to provide a bicycle with a slant backrest frame wherein, via the separate design of the power unit and the bicycle embodiment thereof, the storage battery of the power unit can be individually withdrawn from the receiving cavity of the central tube for recharging, enable a rider to make use of the bicycle embodiment without waiting for the completion of the charging operation thereof.

### BRIEF DESCRIPTION OF THE DRAWINGS

FIG. 1 is a perspective exploded view of the present invention.

FIG. 2 is a perspective view of the present invention in assembly.

FIG. 3 is a cross sectional view of the present invention in assembly.

### DETAILED DESCRIPTION OF THE PREFERRED EMBODIMENTS

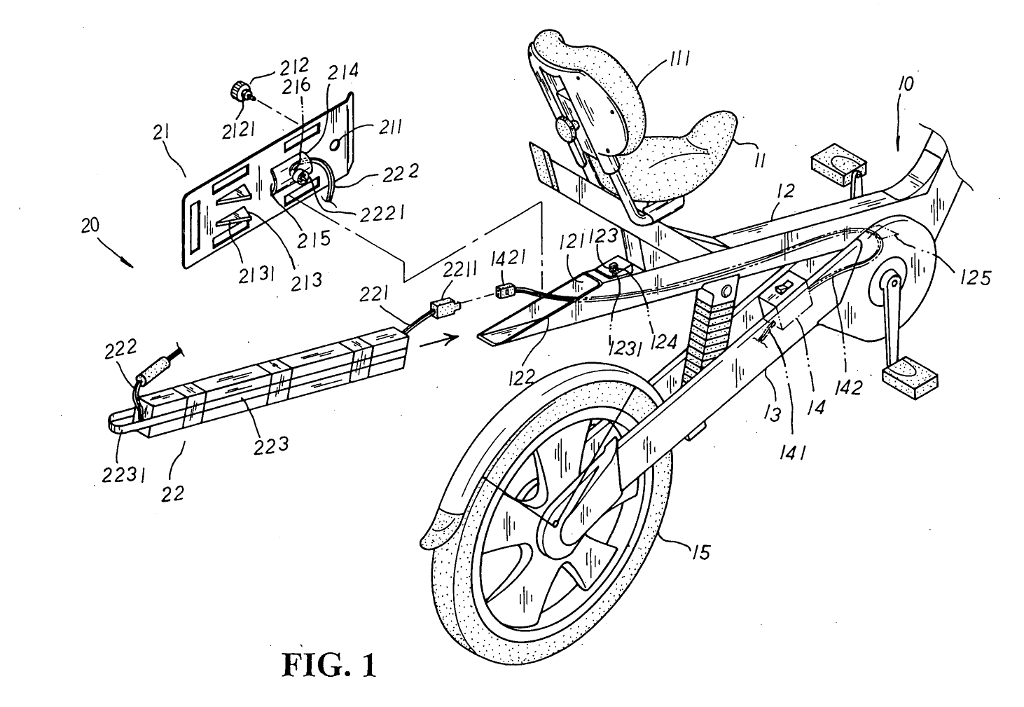

Please refer to FIG. 1. The present invention is related to a bicycle with a slant backrest frame, comprising a bicycle embodiment 10, and a power unit 20. The bicycle embodiment 10 is equipped with a saddle 11 having a slant backrest 111, and a rectangular central tube 12 disposed under the saddle 11 thereof. The central tube 12 thereof has a receiving cavity 121 disposed at the inner side thereof, a slant flat opening 122 levelly cut at the rear side thereof, an annular groove 123 indented at the upper periphery of the slant flat opening 122 thereof for a spring element 1231 to be adapted therein, and a screw hole 124 disposed at the bottom of the annular groove 123 thereof communicating with the receiving cavity 121 thereby. A through hole 125 is disposed at the front side of the central tube 12 to be communicated with a lower tube 13 of the bicycle embodiment 10 thereof. At a preset position of the lower tube thereof is fixedly mounted a switch device 14 having a first electrical wire 141 disposed at one side thereof to be connected with a driving mechanism (without shown in the diagram) of a rear wheel 15, and a second electrical wire 142 disposed at the other side thereof to be led through the through hole 125 of the central tube 12 and extended through the receiving cavity 121 thereof to come out at the slant flat opening 122 thereof with a socket 1421 attached at the end thereto. The power unit 20 is made up of a rear loading bracket 21 and a storage battery 22. The rear loading bracket 21 has a coupling hole 211 disposed at one side thereof correspondingly matched to a screw 212, a pair of elastic clamping plates 213 symmetrically protruding at the other side thereof each having a support edge 2131 cut at the bottom side thereon, and an arc stop block 214 protruding at a preset place thereon to form a retaining groove 215 therein. A wire passage hole 216 is disposed at the middle of the arc stop block 214 thereon, and a step-wise sleeve rod 2121 is extending at the middle section of the screw 212 thereof. The storage battery 22 is provided with a first and a second conducting wires 221, 222 attached at both sides thereof respectively wherein the first conducting wire 221 has a plug 2211 fixed at the end thereto, and the second conducting wire 222 is led from one side of the retaining groove 215 thereof to come out at the wire passage hole 216 there-through. A charging plug 2221 is attached to the end of the second conducting wire 222 extending out at the wire passage hole 216 thereof to abut against the outer side of the stop block 214 for location thereby. A belt body 223 is securely fixed to the middle section of the battery 22 with a handle section 2231 wound at both ends of the storage battery 22 respectively.

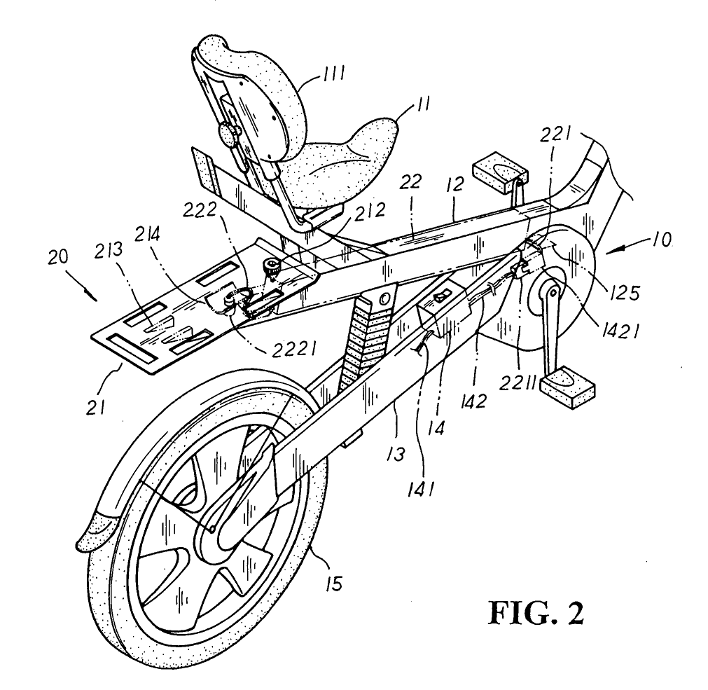

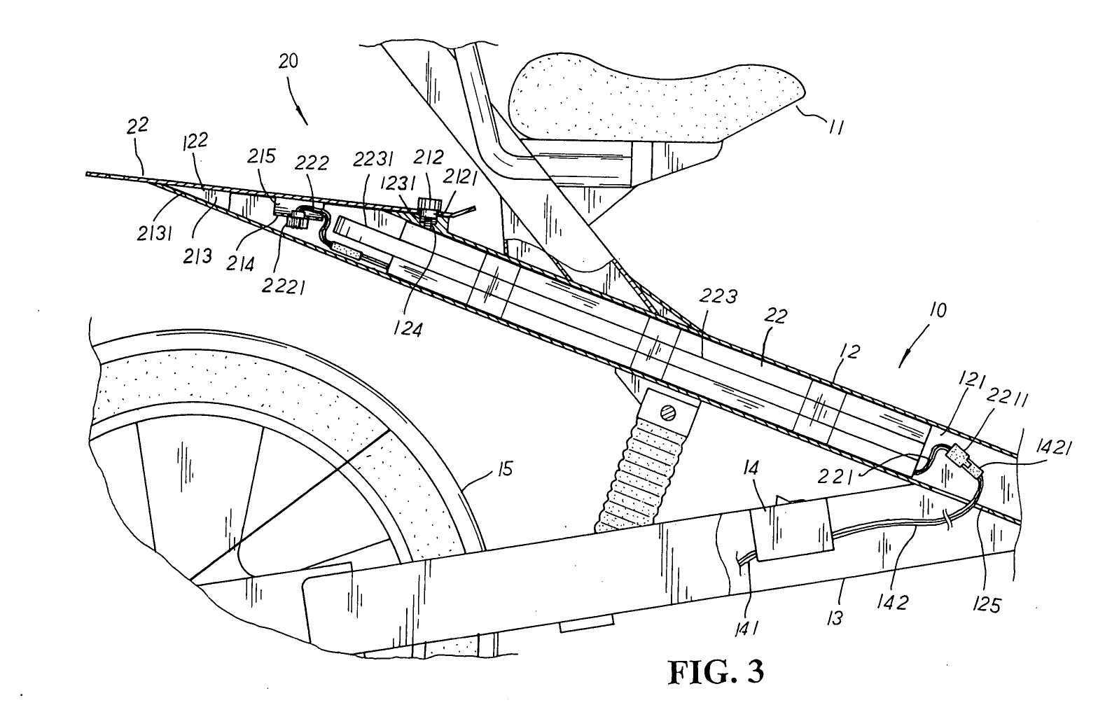

Please refer to FIGS. 2 to 3 inclusive. In assembly, the plug 2211 of the storage battery 22 thereof is conductively inserted to the socket 1421 of the second electrical wire 142 before the storage battery 22 is pushed through the slant flat opening 122 of the central tube 12 and adapted at the receiving cavity 121 therein. The elastic clamping plates 213 of the rear loading bracket 21 are applied to the central tube 12 thereof and flexibly joined to the slant flat opening 122 thereof in sleeve engagement with the support edges 2131 levelly abutted against the bottom side of the receiving cavity 121 thereon. The coupling hole 211 of the rear loading bracket 21 is mutually matched to the annular groove 123 of the central tube 12, and the screw 212 is led through the annular groove 123 via the coupling hole 211 thereof with the sleeve rod 2121 thereof compressing the spring element 1231 adapted at the annular groove 123 therein. The screw 212 led through the coupling hole 211 and the annular groove 123 thereof in a sequence is screwed up to the screw hole 124 thereof, securely fixing the rear loading bracket 21 at the slant flat opening 122 thereon to complete the assembly of the present invention.

Thus, via the power unit 20 conductively linked to the switch device 14 thereof, a rider can freely choose either to simply pedaled the bicycle by feet or to electrically move the bicycle embodiment 10 thereof via the power unit 20 in practical use. When the power unit 40 is turned on via the switch device 14, the rider can comfortably sit back on the saddle 11 with the back leaned properly against the slant backrest 111 thereof, facilitating the use of the slant backrest ill thereof. Besides, the receiving cavity 121 of the central tube 12 is communicated with the lower tube 13 thereof to securely conceal the first/second electrical wires 141, 142, of the switch device 14 and the first/second conducting wires 221, 222 of the storage battery 22 therein, protectively sheltering the storage battery 22 and the wires thereof as well as boosting the beauty of the bicycle embodiment 10 thereof as a whole.

In case the power of the storage battery 22 is used up, the screw 212 is released from the screw hole 124 of the central tube 12 thereof before the rear loading bracket 21 is pulled outwards to detach the elastic clamping plates 213 from the receiving cavity 121 thereof. The storage battery 22 can then be withdrawn from the receiving cavity 121 via the handle section 2231 of the belt body 223 and power is connected to the charging plug 2221 of the storage battery for recharging thereof. Thus, via separate design of the power unit 20 and the bicycle embodiment 10 thereof, the rider can make use of the bicycle embodiment 10 without waiting for the completion of the charging operation thereof.

1. A bicycle with a slant backrest frame, comprising a bicycle embodiment, and a power unit wherein the bicycle embodiment is equipped with a saddle having a slant backrest, and a central tube disposed under the saddle thereof; the present invention being characterized by that,
the central tube having a receiving cavity disposed at the inner side thereof, a slant flat opening cut at the rear side thereof, and a through hole disposed at the front side thereof to be communicated with a lower tube of the bicycle embodiment thereof; at a preset position of the lower tube is fixedly mounted a switch device having a first electrical wire disposed at one side thereof to be connected with a driving mechanism of a rear wheel, and a second electrical wire disposed at the other side thereof to be led through the through hole of the central tube and extended through the receiving cavity thereof to come out at the slant flat opening thereof with a socket attached to the end thereto;
the power unit being made up of a rear loading bracket and a storage battery wherein the rear loading bracket has an arc stop block protruding at a preset place thereon to form a retaining groove therein, and a wire passage hole disposed at the middle of the arc stop block thereon; the storage battery is provided with a first and a second conducting wires attached at both sides thereof respectively wherein the first conducting wire has a plug fixed at the end thereto, and the second conducting wire is led from one side of the retaining groove thereof to come out through the wire passage hole there-through with a charging plug attached to the end thereof and abutted against the outer side of the stop block for location thereby;
thus, besides pedaled by both feet, the bicycle embodiment can also be electrically moved via the power unit conductively linked to the switch device thereof, providing a dual-functional bicycle with a slant backrest frame thereof; with the receiving cavity of th central tube communicated with the lower tube, the first/second electrical wires and the first/second conducting wires thereof are concealed at the central and the lower tubes therein, protectively sheltering the storage battery and the wires therein as well as boosting the beauty of the bicycle embodiment thereof as a whole; moreover, via the separate design of the power unit and the bicycle embodiment, the storage battery can be individually withdrawn from the receiving cavity of the central tube thereof for recharging, enable a rider to make use of the bicycle embodiment without waiting for the completion of the charging operation thereof.

2. The bicycle with a slant backrest frame as claimed in claim 1 wherein the central tube of the bicycle embodiment is formed of a rectangular tubular body in shape.

3. The bicycle with a slant backrest frame as claimed in claim 1 wherein the central tube of the bicycle embodiment has an annular groove indented at the upper periphery of the slant flat opening thereof for a spring element to be adapted therein, and a screw hole disposed at the bottom of the annular groove thereof communicating with the receiving cavity thereby for a screw having a sleeve rod disposed thereon to be correspondingly registered therewith.

4. The bicycle with a slant backrest frame as claimed in claim 1 wherein the rear loading bracket of the power unit is provided with a pair of elastic clamping plates symmetrically protruding at one side thereof each having a support edge cut at the bottom side thereon, and a coupling hole disposed at the other side thereof correspondingly matched to the annular groove of the central tube thereof.

5. The bicycle with a slant backrest frame as claimed in claim 1 wherein the storage battery of the power unit has a belt body securely fixed to the middle section thereof to form a handle section wound at both ends of the storage battery thereof respectively.

6. The bicycle with a slant backrest frame as claimed in claim 3 wherein the rear loading bracket of the power unit is provided with a pair of elastic clamping plates symmetrically protruding at one side thereof each having a support edge cut at the bottom side thereon, and a coupling hole disposed at the other side thereof correspondingly matched to the annular groove of the central tube thereof.
